(19) United States
(12) Patent Application Publication
(10) Pub. No.: US 2003/0042769 A1
(43) Pub. Date: Mar. 6, 2003

(54) Seat post folding structure of a bike

(76) Inventor: Ting-Hsing Chen, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/941,634

(22) Filed: Aug. 30, 2001

(51) Int. Cl. B62J 1/00

(52) U.S. Cl. 297/195.1

(57) ABSTRACT

A seat post folding structure of a bike provides an elastic cord to connect a seat post inserted into a seat tube; wherein, a fixing member provided at the lower end of said seat tube links to the elastic cord with the other end of the elastic cord passing through the seat tube, the seat post to connect a stopper provided on the upper end of the seat post; the seat post then connected to the seat tube with the elastic cord is given with a force of relative insertion force against the seat tube due to the pull by the elastic cord when the bike is used, and can be folded in any direction as desired for storage after having been disengaged from the seat tube.

### BACKGROUND OF THE INVENTION

(a) Field of the Invention

The present invention relates to a seat post folding structure of a bike, and more particularly, to one that allows the seat post connecting with an elastic cord to be folded in any direction without parting from the seat post.

(b) Description of the Prior Art

For the purpose of easy carriage or storage, a bike is designed as foldable to reduce its volume and there are many types of folding mechanism available in the market today. Said folding mechanism generally features a pivoting knuckle or expansion structure at where higher, longer or wider part of the bike, e.g., head tube, central frame and seat post to fold in or shorten bike tube and post to facilitate carriage or storage.

However, usually the seat post is designed with a fast clamp provided at top of the seat tube to secure the seat post inserted into the seat tube, and to allow fast release of the clamp for the seat post to become retractable against the seat tube in adjusting the height of the seat to where it can be descended. Furthermore, another improvement has a pivoting knuckle provided in the inner end at where the seat post is inserted into the seat tube so that once the seat post is pulled out and held in position by having exposed its pivoting portion out of the seat tube, the seat post can be folded in relation to the seat tube to rest the seat against the frame. However, as said pivoting knuckle refers to a rigid structure and allows folding only in one direction, the user tends to feel awkward while manipulating the folding mechanism. Besides, said pivoting structure needs to be able to slide inside the seat tube and restricted in position at the end of the seat tube, the production cost is higher due to the adapting structure is very complicate in general.

### SUMMARY OF THE INVENTION

The primary purpose of the present invention is to provide a seat post folding structure for a bike to allow a seat post be folded in any direction as desired once it is disengaged from a seat tube for easy carriage or storage of the bike. To achieve the purpose, a fixing member is provided at the lower end of the seat tube to connect an elastic cord and the other end of the elastic cord passes through the seat tube and the seat post and finally connect a stopper at the upper end of the seat post. With the seat post and the seat tube connected with the elastic cord, the seat post is given with a relative insertion force against the seat tube for being subject to the pull by the elastic cord. When pulled out of the seat tube, the seat post can be folded in any direction as desired by the extended elastic cord.

### BRIEF DESCRIPTION OF THE DRAWINGS

FIG. 1 is an exploded view of a preferred embodiment of the present invention.

FIG. 2 is a schematic view showing that the preferred embodiment of the present invention is adapted to a bike.

FIG. 3 is a schematic view showing the preferred embodiment of the present invention in a status ready for folding.

FIG. 4 is a schematic view showing the preferred embodiment of the present invention in a status after folding.

FIG. 5 shows another preferred embodiment of the present invention.

### DETAILED DESCRIPTION OF THE PREFERRED EMBODIMENTS

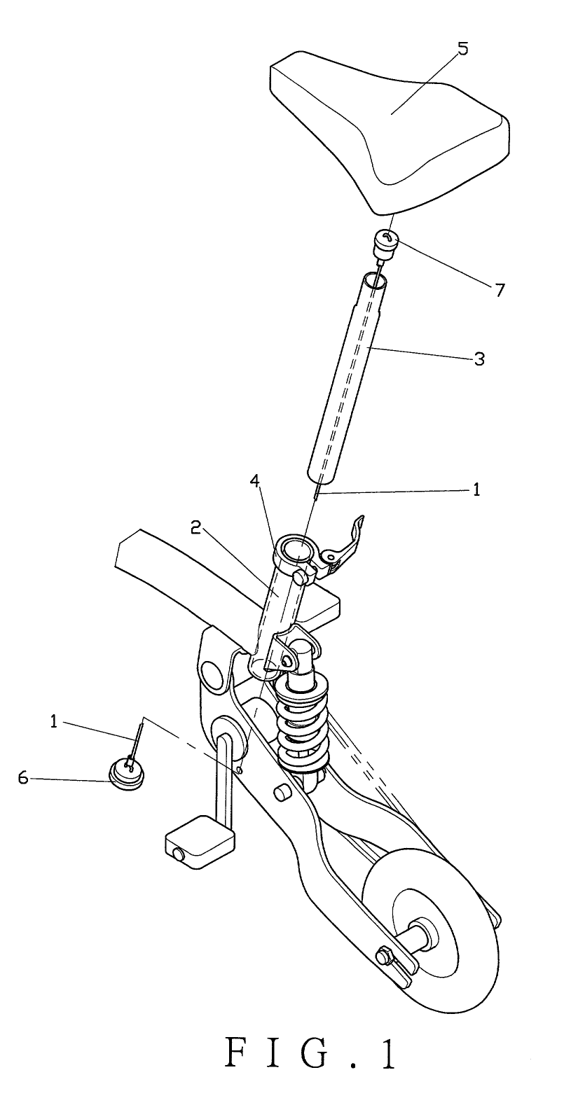

Referring to FIG. 1, a preferred embodiment of the present invention for an improved structure of a seat post is essentially composed of an elastic cord (1) connecting the seat post (3) inserted in a seat tube (2), a fast clamp (4) capped onto the upper end of the seat tube (2) to secure the seat post (3) in the seat tube (2), thus to hold a seat (5) in position at a proper height. A fixing member (6) is connected to the bottom end of the seat tube (2) and attached to one end of the elastic cord (1). The other end of the elastic cord (1) passes through the seat tube (2) and the seat post (3). A stopper (7) is provided at the upper end of the seat post (3) for the elastic cord (1) to respectively connect the seat post (3) and the seat tube (2) by linking at its both ends to the stopper (7) and the fixing member (6), thus to give the seat post (3) a relative insertion force into the seat tube (2) for being subject to the pull by the elastic cord (1).

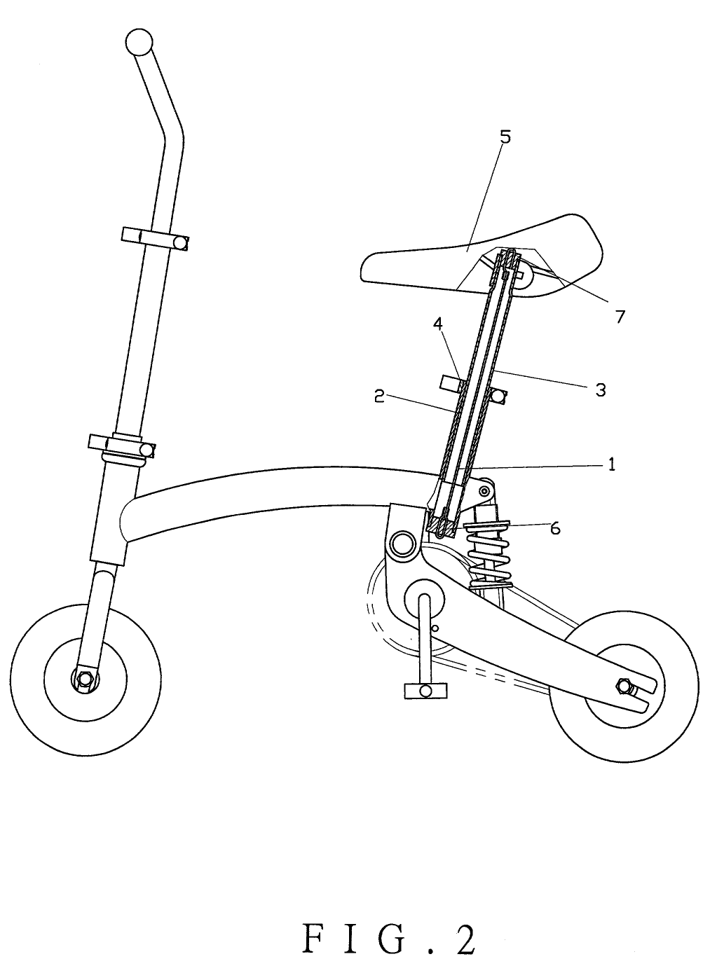

As illustrated in FIG. 2, the top of the seat tube (2) is inserted with the fast clamp (4) to fix the seat post (3) into the seat tube (2). The seat (5) then is adjusted to a proper height for the fast clamp (4) to fasten the top end of the seat tube (2), and secure the seat post (3) in position. The elastic cord (1) is thus concealed in the seat tube (2) and the seat post (3) and connects both of the seat tube (2) and the seat post (3) with the fixing member (6) and the stopper (7).

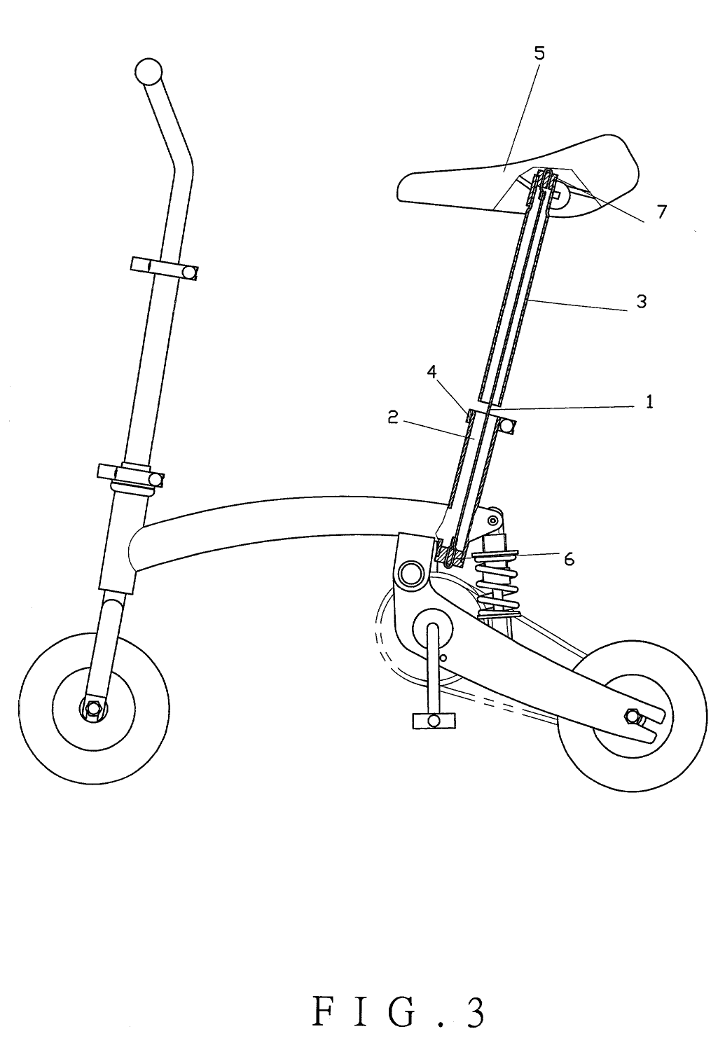

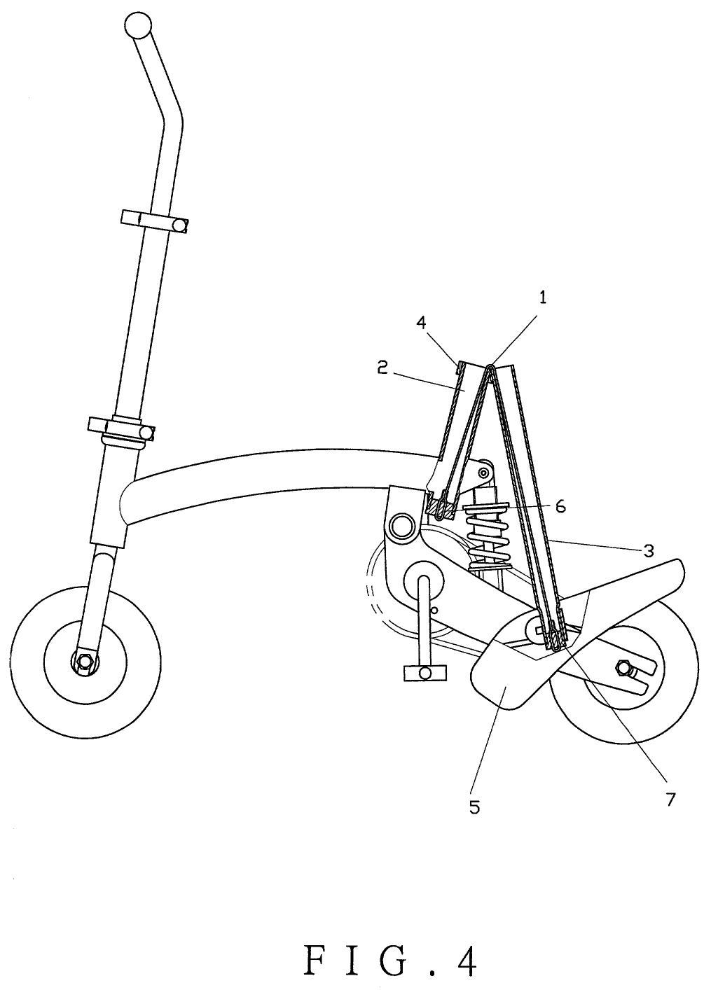

Upon folding the seat post (3) and the seat (5) to rest on the frame of the bike as illustrated in FIG. 3, the fast clamp (4) is released to pull out the seat post (3) out of the seat tube (2) so that the elastic cord (4) is stretched. Referring to FIG. 4, with the elastic cord (4) stretched, the seat post (3) is disengaged but not parting from the seat tube (2) while allowing itself to be folded in any direction at any angle against the seat tube (2) and resting on either side of the frame of the bike for easy carriage and storage.

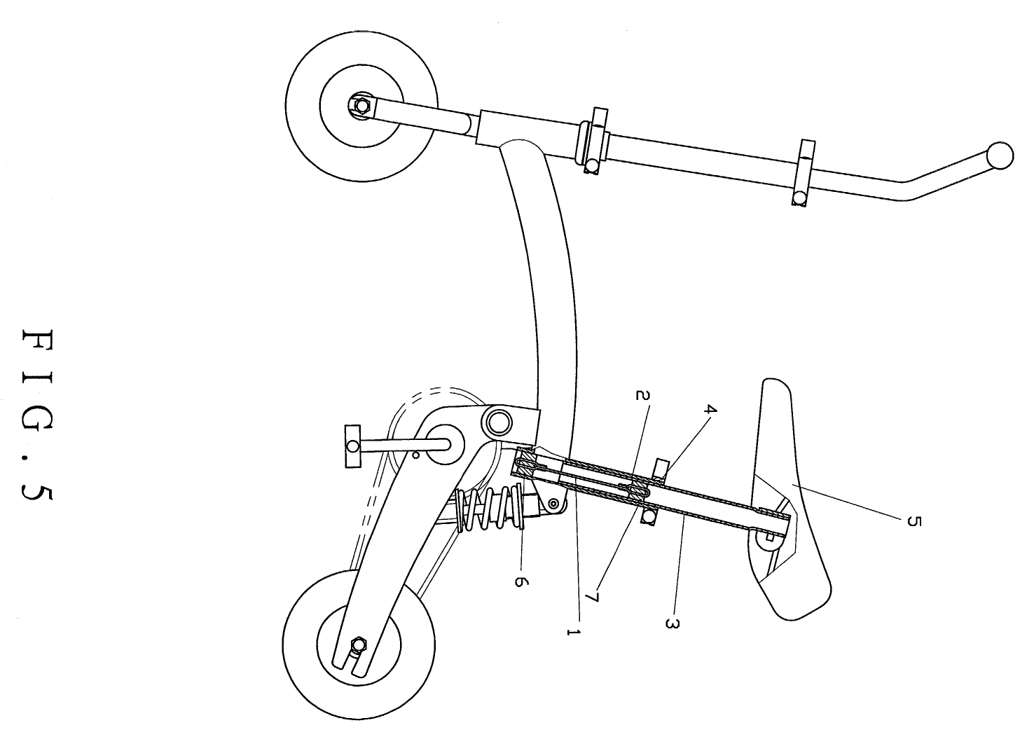

Referring to FIG. 5, another preferred embodiment of the present invention has the fixing member (6) provided at where appropriately inside the seat tube (2) and the stopper (7) fixed inside the seat post (3) while both ends of the elastic cord (4) respectively connected to the fixing member (6) and the stopper (7) inside the seat tube (2) and the seat post (3).

As disclosed, the present invention by having the seat tube and the seat post connected with the elastic cord so that the seat post can be pulled out and disengaged from the seat tube but not parting from it to be folded in any direction to facilitate carriage or storage of the bike provides an innovative and practical improvement of the prior art.

I claim:

1. A seat post folding structure of a bike having a seat post connected with a seat tube with an elastic cord, wherein:
one end of said elastic cord connected to a fixing member at lower end of said seat tube or at an appropriate section of said seat tube, and the other end of said elastic cord passing through said seat tube and said seat post, a stopper provided at the upper end of said seat post or in said seat post for said seat post being subject to the pull from said elastic cord being given a relative insertion force into said seat tube; and can be folded in any direction as desired for storage once having disengaged from said seat tube.
